(19) United States
(12) Patent Application Publication
(10) Pub. No.: US 2003/0160006 A1
(43) Pub. Date: Aug. 28, 2003

(54) Separation apparatus with conveyor and separating hopper

(76) Inventor: Paul Lindh, Loddekopinge (SE)

Correspondence Address: HARNESS, DICKEY & PIERCE, P.L.C., P.O. BOX 8910, RESTON, VA, 20195, US

(21) Appl. No.: 10/275,430

(22) PCT Filed: May 9, 2001
(86) PCT No.: PCT/SE01/01006

(30) Foreign Application Priority Data
May 9, 2000 (SE) 0001693-1
Oct. 13, 2000 (SE) 0003698-8

(51) Int. Cl. C02F 1/00

(52) U.S. Cl. 210/768

(57) ABSTRACT

The invention relates to an apparatus for separating impurities from waste water. The apparatus comprises a separating portion (40) for separating solid impurities from the waste water, a water storage tank (10) for storing at least partly purified waste water, a collecting vessel (20) for collecting the separated solid impurities, and a conveyor (30) which extends from the separating portion (40) to the collecting vessel (20), the separating portion (40) comprising an inlet (41a) through which waste water is passed to the separation apparatus, a water outlet (44) for removing water, which is connected to the water storage tank (10), and an impurity outlet (43) for removing the solid impurities, which is connected to the collecting vessel (20). Moreover, the invention concerns a method for separating impurities from waste water.

### FIELD OF THE INVENTION

The present invention relates to an apparatus and a method for separating impurities from waste water.

### BACKGROUND ART

Today's waste water treatment systems are impaired by many problems, for instance regarding treatment of sludge, consumption of water, and accumulation of heavy metals. When penetrating the various issues, it will be realised that there is currently no functioning system for treating waste water. Industrial waste water and process water containing chemical impurities is a special case where there is still a lot to do, but also the present way of treating waste water from dwellings is untenable when taking the long view.

In today's model of recycling system, the waste water treatment plants separate nutritious sludge and spread it on arable land. What happens in this treatment system is that the nutritive substances of the sludge are taken care of and that large quantities of organic waste are disposed of. The current technique of treating the waste water, however, means that excessive amounts of heavy metals are accumulated on arable land and, thus, in crops that are grown on arable land.

The largest amount of heavy metals in the water is supplied from sewage piping and all metal objects with which the water comes into contact. Each individual produces about 1.3 litres of faeces and urine a day. This amount should be compared with the total volume of waste water (bath, shower, washing, washing up etc.) of more than 200 litres a day that an individual in the Western World produces. This ratio of volumes implies that also small amounts of heavy metals in the water result in excessive concentrations of heavy metal in the sludge that is spread on arable land.

Today's waste water treatment systems are thus not satisfactory from the viewpoint of recycling since they cause accumulation of heavy metals in water and on arable land. Also other metals are accumulated in very high concentrations, but in many cases the problems are focused on heavy metals since their harmful effects are in most cases more obvious.

Other problems that are associated with today's water and waste water systems are that too large amounts of water are being used. Large amounts of water cause the release of large amounts of metals in water. Although there are often low concentrations in the water, the large amounts imply that there will be high concentrations where the metals are capable of accumulating. Examples of places of accumulation are arable land, plants, animals and people.

Thus a satisfactory method of treating waste water is not available.

### SUMMARY OF THE INVENTION

The object of the invention is to provide a solution to, or at least alleviate, the problems that are associated with prior-art technique.

A special object is to provide a solution to the treatment of organic waste from dwellings or the like.

The above objects are achieved by means of an apparatus which is characterised in that it comprises a separating portion for separating solid impurities from the waste water, a water storage tank for storing at least partly purified waste water, a collecting vessel for collecting the separated solid impurities, and a conveyor extending from the separating portion to the collecting vessel, the separating portion comprising an inlet through which waste water is passed to the separation apparatus, a water outlet for removing water, which is connected to the water storage tank, and an impurity outlet for removing the solid impurities, which is connected to the collecting vessel.

By designing the separation apparatus in this fashion, a waste water treatment plant is obtained which releases relatively pure water and which removes solid impurities from the waste water.

An important advantage compared with prior-art solutions is that in the inventive separation apparatus, the contact between the impurities and the waste water is minimised both in respect of time and volume. This is achieved owing to the facts that the apparatus as such mechanically separates the impurities from the waste water and that the apparatus can be connected practically directly to a dwelling or the like, whereby only moderate amounts of water are required to transport the impurities to the separation apparatus.

The separation apparatus can be connected to a large common sewage piping so that the partly purified water is passed on to central sewage treatment works, but it can also work as local, more or less complete sewage treatment works. Even if the separation apparatus is connected to a common sewage piping, the advantage is achieved that the central sewage treatment works need not separate large amounts of sludge containing heavy metals. By separating the solid impurities, which from a dwelling mainly involves faeces from one or more toilets, and collecting them in a collecting vessel, these impurities can be composted and thus be eliminated essentially completely. Even if spreading of these impurities should be chosen, a very large part of the accumulation of heavy metals has been avoided since the sludge is transported but a short distance together with waste water containing heavy metals.

The inventive apparatus thus has a number of different fields of application and has in all the cases eliminated or at least significantly reduced the problems relating to treatment of sludge, consumption of water and accumulation of heavy metals in the recycling system.

The above objects are also achieved by a method which has the same advantages as the inventive apparatus and which is characterised in that it comprises the steps of supplying waste water to a separating portion, separating in the separating portion solid impurities from the waste water, passing the impurities from the separating portion to a collecting vessel, passing the partly purified waste water from the separating portion to a water storage tank.

Preferred embodiments are evident from the dependent claims.

Advantageously the water outlet of the separating portion is located below the impurity outlet of the separating portion, which makes it possible to utilise gravity for the waste water and thus reduce the need for additional pumps or valves.

These advantages regarding pumps and valves can also be achieved if the water outlet of the separating portion is located below the inlet of the separating portion according to a preferred embodiment.

Suitably the separating portion is located below the collecting vessel. This results in automatic dewatering of the impurities that are conveyed upwards to the collecting vessel. Moreover, according to this construction water that is drained from the impurities can automatically be recirculated to the separating portion and thus be conducted the same way as the remainder of the partly purified water.

According to a preferred embodiment, the water storage tank and the collecting vessel are arranged to be in heat transfer contact with each other. This allows utilisation of the heat content that the water has acquired during the period it stays in the dwelling or the like. The heat is conducted to the collecting vessel and the composting of the impurities proceeding therein, which causes the composting to continue under favourable conditions.

Advantageously the water storage tank and the collecting vessel are jointly thermally insulated from the surroundings. This improves the heat exchange still more and also ensures that the heat does not disappear unnecessarily in the surroundings. Moreover, the risk is reduced that the compost is damaged by frost since the water has a fairly great heat content, which allows the compost to withstand relatively strong cold without being damaged. According to a preferred embodiment, the conveyor is adapted to extend through the impurity outlet into the separating portion, to be in contact with waste water supplied to the separating portion, and to separate solid impurities from the waste water and entrain them to the collecting vessel. This is a simple way of carrying out the separation and it is a simple way of passing the separated impurities to the conveyor. To avoid unnecessarily frequent intervals for servicing it is important for movable components to interact in a simple manner, which in turn makes it easy to construct and dimension the components correctly.

According to a preferred embodiment, the water storage tank is divided into a first and second tank, which makes it easier to separate water which is stagnant for sludge separation and water which is, for instance, oxygenated.

For similar reasons, the first and the second tank advantageously communicate with each other through an overflow from the second tank to the first tank.

According to a preferred embodiment, the separation apparatus further comprises a first, upwardly open and downwardly tapering hopper which is adapted to receive water from the separating portion and pass this to the water storage tank. As a result, the separation of sludge is to a still greater extent prevented from being interfered with by turbulence in the water.

By arranging said hopper in the water storage tank, it is possible to easily recover the heat that is initially contained in the waste water.

Advantageously, said hopper conducts the water to the second tank to allow sludge to be separated in the second tank.

According to a preferred embodiment, the separation apparatus further comprises a second, downwardly open and upwardly tapering hopper which communicates with said first hopper. As a result, turbulence in the masses of water is easily prevented from being passed on, and particles are prevented from floating upwards and clogging subsequent filters, pumps etc, but it is instead ensured that the particles flow upwards to practically the same place as is adapted to receive the initially supplied, relatively contaminated water.

Advantageously the first hopper is arranged in the first tank, and the second hopper is arranged in the second tank. This improves the functionality of the hopper as regards reduction of turbulence and directing of particles.

According to one aspect of the invention, the separation apparatus is connected to one or more sources of pollution in such manner that waste water from heavy sources of pollution, such as toilets, waste disposers or the like, and waste water from not so heavy sources of pollution, such as showers, wash basins and the like, are not supplied to the separation apparatus simultaneously. This can be solved, for example, by the separation apparatus being connected to a single dwelling where it is not likely that water from a plurality of sources of pollution is discharged simultaneously. This can be supplemented with toilets using time-controlled flushing or other systems by means of which it is possible to control when waste water is discharged from the respective types of source of pollution. If sources of pollution with controlled flushing are used, it is possible to connect a relatively large number of sources of pollution to a separation apparatus. Criteria that are crucial to enable full utilisation of the inventive separation apparatus are that the heavily polluted waste water is not mixed with less polluted waste water and that the time of faeces or other impurities being in contact with the waste water is as short as possible.

### BRIEF DESCRIPTION OF THE DRAWINGS

The invention will now be described in more detail with reference to the accompanying schematic drawings which by way of example illustrate currently preferred embodiments of the invention.

FIG. 1 is a top plan view of a separation apparatus according to a preferred embodiment of the invention.

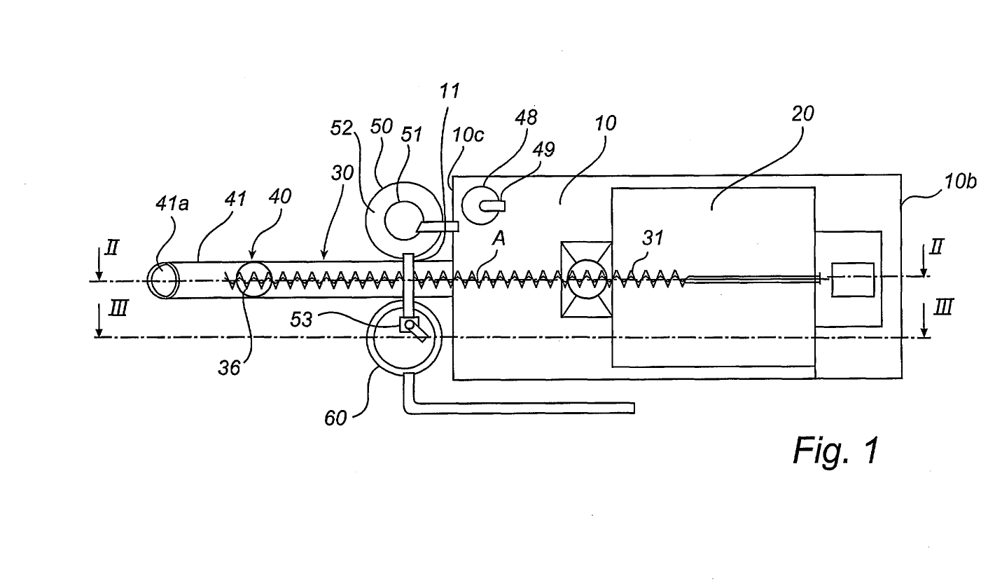

FIG. 2 is a cross-sectional view along line II-II in FIG. 1.

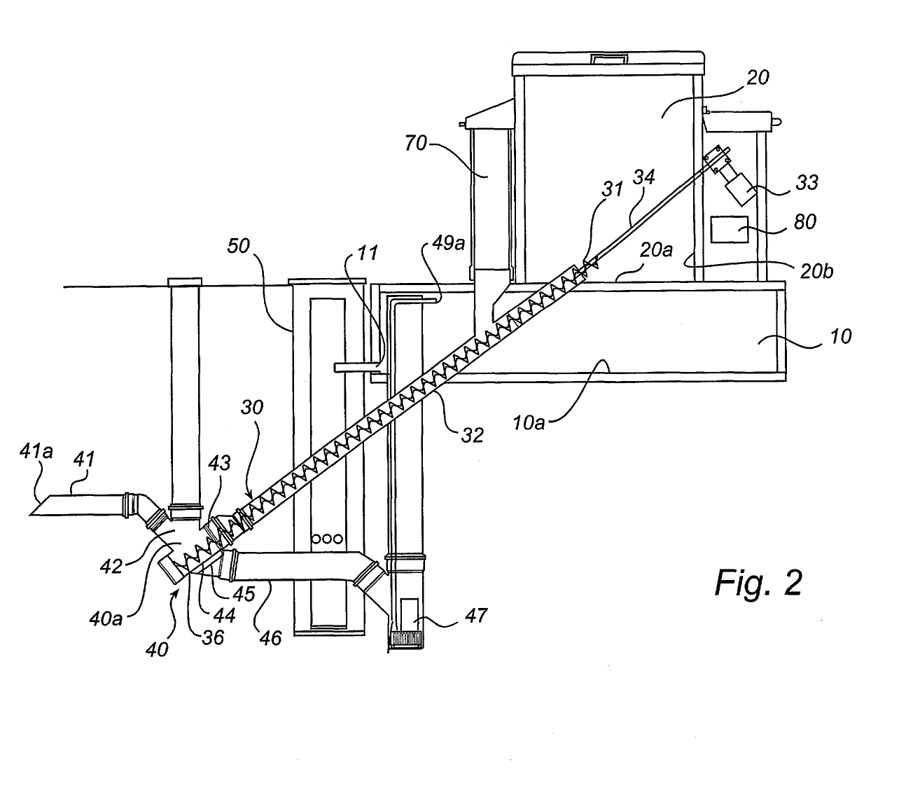

FIG. 3 is a cross-sectional view along line III-III in FIG. 1.

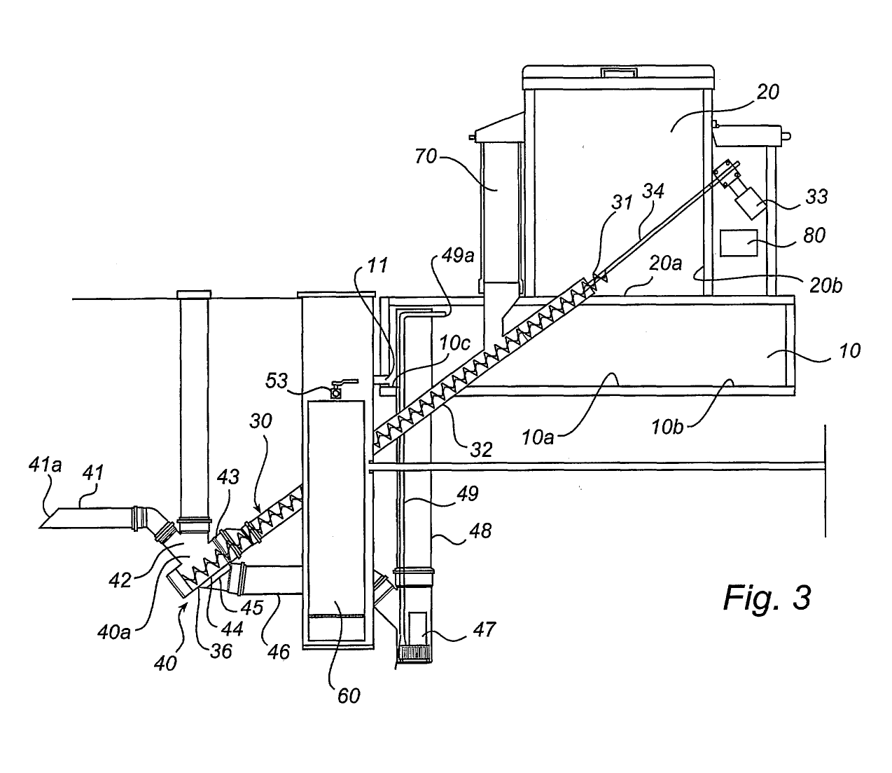

FIG. 4 is a front view of the separation apparatus in FIG. 1.

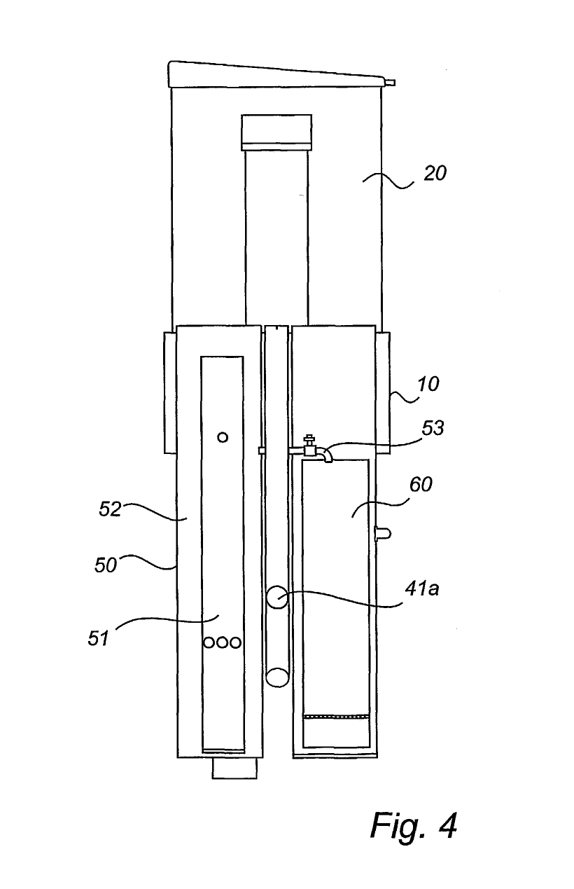

FIG. 5 is a cross-sectional view of a separation apparatus according to a second preferred embodiment corresponding to the cross-sectional view shown in FIG. 2 of the separation apparatus according to a first preferred embodiment.

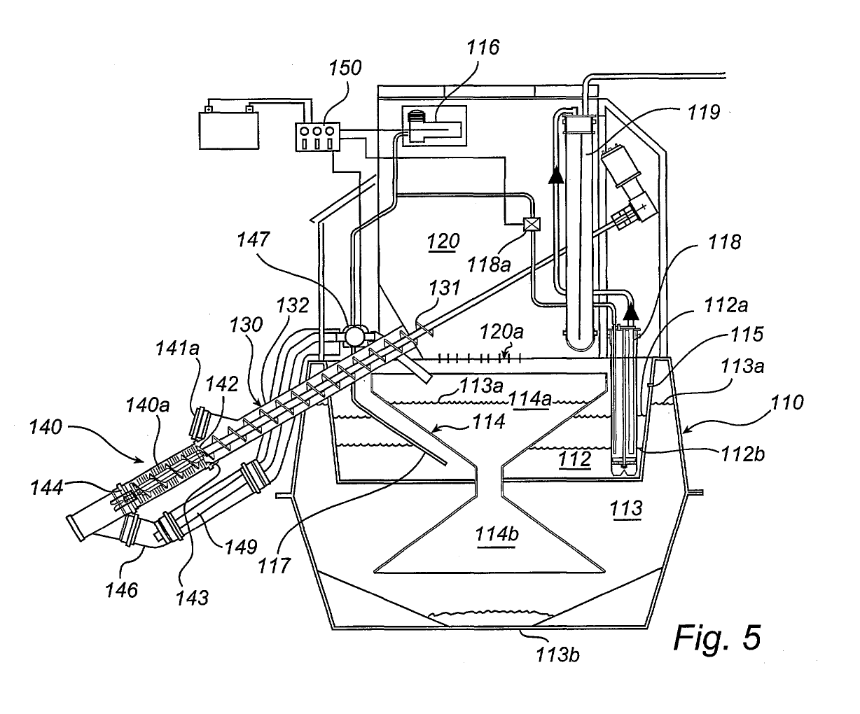

### DETAILED DESCRIPTION OF PREFERRED EMBODIMENTS

As is evident from the drawings, the separation apparatus comprises a water tank 10, a collecting vessel 20 and a conveyor 30, which extends between a separating portion 40 and the collecting vessel 20. The separation apparatus is above all intended to purify water by separating solid organic waste, such as faeces and the like, from waste water coming from one or a number of dwellings.

The waste water which is to be purified is passed from the source of pollution, such as a toilet, waste disposer or the like, to an inlet 41a of an inlet pipe 41 through which the waste water is passed to the separating portion 40. The separating portion 40 comprises a separation chamber 40a with a number of openings 42-44. The inlet pipe 41 is connected to an opening 42, and the conveyor 30 extends through another opening 43 into the separation chamber 40a. The separation chamber 40a further has an opening 44 through which partly purified water is discharged from the separating portion 40. The separation essentially takes place in the separating portion 40 and is carried out essentially by the conveyor 30 pulling solid particles out of the waste water in the separation chamber and entraining them to the collecting vessel 20.

The separation chamber 40a is formed of a joint of pipes and the openings 42-44 are pipe sockets or open pipe ends. The inlet opening 42 for supplying waste water is located above the outlet opening 44 for the partly purified water. The opening 43 for the conveyor 30 is also located above the outlet opening 44. This design and location of the various openings makes it possible to use gravity and let the supplied waste water flow by gravity to a large extent, thus minimising the need for pumps and pressurising of the apparatus.

The outlet opening 44 for the partly purified water is covered by a filtering unit 45 which can be, for example, a screen in the form of an apertured metal plate, a grid screen, or filter cloth. The selection of filtering unit 45 depends on, for example, flow of water, particle form and particle size, time of use, service intervals. The filtering unit 45 should let through a sufficient amount of water but should stop solid particles so that they can be removed by the conveyor 30 instead of accompanying the water out of the separating portion 40.

A pipe 46 is connected to the outlet opening 44 and is adapted to conduct the partly purified water downwards to a pump 47. The pump 47 is positioned in the bottom 48a of a pipe 40 through which it is possible to lift up the pump 47 for service, repair or exchange. The bottom 48a of the pipe 48 is positioned below the outlet opening 44 in the separating portion 40 and serves to collect water and, in some cases, serve as a small buffer tank for the water that is to be pumped on by the pump 37.

The pump 47 is adapted to pump the partly purified water up to the water tank 10 via a water pipe 49 which extends inside the pipe 48 in which the pump 47 is arranged. The water pipe 49 has an upper end curved at right angles and has a horizontally oriented outlet 49a which is located at the upper portion of the water tank 10.

The water tank 10 has an outlet 11 which is located at its bottom 10a which is slightly inclined or curved in such manner that one end 10b of the bottom 10a is lower than the other end 10c. The end 10c at which the outlet 11 is placed is located above the bottom 10a of the other end 10b. This design makes it possible to utilise settling of particles in the water contained in the water tank 10. Owing to the inclination, the settled particles are not entrained through the outlet, but are instead deposited as the separation apparatus is being used, and thus they can be removed when cleaning or servicing the apparatus. By designing the apparatus in such manner that the lowest portion is located at an end 10b, it will be easy to reach and clean the tank.

The conveyor 30 is a screw conveyor and comprises a screw 31 which is concentrically arranged in a pipe 32. The pipe 32 is stationary and the screw 31 is rotated in the pipe by means of an electric motor 33. The conveyor 30 is directed obliquely upwards and extends from the separating portion 40 up to the collecting vessel 20 to which it connects in the centre of the bottom surface 20a of the collecting vessel 20. The screw 31 extends somewhat further into the collecting vessel 20 than does the pipe 32. The screw 31 is connected to a drive shaft 34 which extends concentrically further obliquely upwards and out through a side wall 20b of the collecting vessel 20. Outside the collecting vessel 20 the drive shaft 34 is connected to the above-mentioned electric motor 33. The screw 31 is a self-supporting flange describing a helical line round the longitudinal axis A of the conveyor. The flange is oriented so that its largest extent is radially directed and its smallest extent is axially directed. Thus the flange defines a thread-like configuration. The screw 31 has an open interior, i.e. the flange extends in the radial direction between an inner radius and an outer radius.

The water tank 10 and the collecting vessel 20 are in heat transfer contact with each other and are jointly insulated from the surroundings. This makes it possible to recover the heat from the water and let it assist in the process of decay in the collecting vessel 20. The water obtains its heat, for example, by being stagnant in the flushing cistern of a toilet and being heated to room temperature, or by people showering, washing, and washing up in hot water.

The outlet 11 from the water tank 10 can be connected to a number of subsequent filtration plants. Immediately after the water tank 10 follows a sand filter 50 which is in direct contact with the water tank 10. The sand filter 50 has an inner sludge separator 51 through which the water is passed downwards and an outer conventional sand filter 52 through which the water is recirculated upwards. After the first sand filter 50, the water is passed via a flow control to a second sand filter 60. Subsequently the water can, if desired, be conducted past e.g. a UV source or the like, thus efficiently killing bacteria in the water. These subsequent filtration plants can also be replaced by, for example, some other conventional purifying process. However, it is above all preferred in most cases to use the first filter with a sludge separator 51 and a sand filter 53.

The separation apparatus further comprises a compost chute 70 connecting to the conveyor 30 just before the conveyor connects to the collecting vessel 20.

The above-described separating portion 40 is mainly made up of an end of the pipe 32 in which the screw conveyor 31 extends. The screw 31 has along its lowermost turns radially directed brushes 36 which are adapted to abut against the filtering unit 45 which covers the outlet 44 from the separating portion 40. The brushes 36 rotate with the screw 31 and thereby clean the filtering unit 45 and thus prevent this from clogging.

Moreover, the separation apparatus comprises an air compressor 80 which is adapted to supply air and, thus, oxygen to the water. The oxygenation is important in view of the purifying effect in the sand filters. The air can essentially be supplied to the water at any point in the process, but the important thing is that air is not supplied to the water tank 10 in such manner as to interfere with the sedimentation in the cases where this particle property is utilised.

Summing up, a preferred way of using the separation apparatus will be described.

Heavily polluted waste water from a toilet or the like is conducted to the separation apparatus through the inlet 41a and the pipe 41 to the separating portion 40. When the heavily polluted water flows to the separating portion 40, the electric motor 33 which drives the screw conveyor 31 starts. The starting of the motor 33 can take place by a float being influenced by the heavy flow or by using toilets or the like which generate a control signal when being flushed. The screw 31 entrains the solid impurities, such as faeces or the like, and pulls them a distance up in the pipe 32. After operating for a while, the motor 33 and the screw 31 stop. The impurities that have been pulled up a distance are then further dewatered by excess water flowing back downwards in the pipe 32 back to the separating portion 40. In the separating portion 40, water flows through the outlet 44 through the filtering unit 45 which stops solid particles exceeding a certain size. The recirculated water from the dewatering in the pipe 32 also flows this way. The water is passed on through a horizontally oriented pipe 46 forming a small chamber. The pipe 46 can, of course, be designed so that the chamber effect is enhanced. The pipe 46 is in turn connected to a vertically directed pipe 48 at the bottom of which the pump 47 is arranged. The pump 47 pumps the water up to the water tank 10, in which the water and the particles transported by the water are given the possibility of being stagnant for some time, thereby making it possible for the particles to settle and sink to the bottom 10a of the tank 10. Since the bottom 10a of the tank 10 is inclined or curved, the particles will tend to settle in that portion of the tank 10 which has the lowermost bottom portion 10b, which makes it easier to reach the tank 10 for cleaning and removing the accumulated sludge. The water stagnant in the water tank 10 emits its heat content to the jointly insulated collecting vessel 20 which is placed above the water tank 10. This allows the composting in the collecting vessel 20 to proceed with good efficiency. In subsequent flushing operations, the same procedure takes place once more, in which the impurities that are positioned in the screw conveyor halfway up to the collecting vessel 20 are transported up to the compost. To supply the new impurities to the bottom of the compost is favourable for the sake of composting in view of nutritive substances, oxygenation and the heat content of the new impurities. It goes without saying that the motor 33 can be controlled in other manners. For instance, several runs may be necessary to transport the impurities all the way, or the motor 33 can be controlled in such manner that it transports the impurities all the way in a single run. Alternatively, the motor 33 can be run between flushing operations and the impurities can then be pulled up once they are considered to have an appropriate water content. The governing factor is the proceeding of composting. Moreover the compressor 80 can be started, for example in connection with a flushing, but just like in the case of the motor 33 it is not the time itself which is crucial, but it is the oxygenation level that is the governing parameter.

A second preferred embodiment will now be described in brief. The components that distinguish the second embodiment from the first embodiment will be described.

As is evident from the drawings, the separation apparatus comprises a water tank 110, a collecting vessel 120 and a conveyor 130 which extends between a separating portion 140 and the collecting vessel 120.

The waste water that is to be purified is passed from the source of pollution, such as a toilet, waste disposer or the like, to an inlet 141a belonging to an inlet pipe through which the waste water is conducted to the separating portion 140. The separating portion 140 comprises a separating chamber 140a with a number of openings 142, 144. The inlet pipe is connected to an opening 142 through which opening 142 the conveyor 130 extends into the separating chamber 140a. The separating chamber 140a also has an opening 144 through which partly purified water is discharged from the separating portion 140.

A pipe 146 is connected to the outlet opening 144 and is adapted to conduct the partly purified water. Down into the pipe 146 extends a smaller pipe or flexible tube 149 by means of which a vacuum pump 147 is adapted to pump the water up to the water tank 110.

The water tank 110 comprises an upper tank 112 for clean water and a lower tank 113 for polluted water, and a separating hopper 114 in the shape of an hour glass. The water purified by the screw conveyor 130 is pumped by means of the pump 147 up to the upper part 114a. The water surface 113a is positioned fairly higher up in the upper part 114a of the hopper 114. The shape of the hopper 114 makes turbulence caused by the pump 147 not propagate downwards in the tank 110 to the bottom 113b of the lower tank 113. Sludge in the water supplied by the pump 147 sinks to the bottom 113b where it is accumulated. Certain light-weight particles will first float on the surface 113a in the upper part 114a of the hopper 114, but as the decomposition continues the particles will fall to the bottom 113b. The lower part 114b of the hopper which is open towards the bottom 113b of the tank and which tapers upwards ensures that particles which have been stirred up, fermented and become light, or for some other reason are floating, do not rise to the surface at the sides of the tank 113 but instead in the centre of the tank 113 to the upper part 114a of the hopper 114. The function of the hopper 114 is improved by the bottom 113b of the tank 113 being cup-shaped so that the sludge will be naturally deposited straight under the hopper.

When the water level 113a in the lower tank 113 rises to a certain level, the water purified in the lower tank 113 will flow through a number of openings 115 arranged round the periphery of the tank 112 into the upper tank 112. In the upper tank 112, the water is oxygenated by means of a compressor 116 and a tube 117 extending from the compressor 116 down into the tank 112.

From the upper tank 112 the water is pumped by means of an air-operated piston pump 118 to a U-shaped sand filter 119 and further out to a central sewage system or for irrigation of land or the like. The pump 118 is activated if the water level in the upper tank 112 rises above a certain level 112a and is stopped when the water level falls below a certain level 112b. This buffer quantity of water is approximately 200 litres. The pump 118 is controlled by a central control circuit 150 controlling a valve 118a.

The central control circuit 150 controls, among other things, also the screw conveyor 130, the vacuum pump 147 and the compressor 116.

The lower tank 113 can hold a water volume of about 1500 litres. The above-mentioned capacities as regards volume and the like are adjusted to a household of four people who for shower, toilet, kitchen, washing and the like consume about 600-700 litres a day.

The sludge which is deposited on the bottom 113b of the lower tank 113 can be drawn up to the compost in the collecting vessel 120 by means of a sludge exhauster. It will probably be sufficient to empty the tank 113 of sludge once a year, which can then be carried out at the usual service intervals. Alternatively, this can take place automatically, for instance once a month.

The bottom of the collecting vessel 120 comprises, at least in a portion 120a thereof, a filter cloth through which water that has been conveyed up to the compost can fall in drops into the upper part 114a of the hopper 114.

According to how easy it is to bury the water storage tank 110 and according to the depth at which the sewage system of the house is located, it may be appropriate to adjust the height of the inlet pipe 141a in relation to the rest of the separation apparatus. This is carried out in a simple manner by extending the screw conveyor 130 and the pipe 149 extended parallel with the conveyor 130, so that the inlet 141a will be located at the desired level. The water storage tank 110 is intended to be buried completely, which requires a cavity which is of a depth of slightly more than one metre.

The screw conveyor 130 is adapted to be started in response to three different signals: when flushing a toilet or the like, in response to opening of the waste disposer, and in response to an excessive water level in the conveyor 130. The latter is a sign indicating that the outlet 144 from the separating portion 140 is blocked.

The U filter 119 is adapted to receive the water from the tank 112 in an optional direction, which makes it possible, at regular intervals, to change direction of the water flow and thus clean the filter. Preferably, the first quantity of water after such a change of flow direction is conducted to the upper part 114a of the hopper 114, instead of away from the separation apparatus. It will be appreciated that many modifications of the described embodiments of the invention are feasible within the scope of the invention, which is defined in the appended claims.

For example, the water tank and the collecting vessel can have shapes other than the shown rectangular and square shape. A circular shape is another convenient shape which facilitates manufacture and function. The bottom face of the water tank can then be, for example, curved so that the basin or tank is deeper at the outer circumference than it is in the centre of-the tank, which makes it easy to reach settled deposits, if any, through inspection covers in the outer and upper portions of the tank. The outlet is conveniently arranged in the centre of the tank.

Complementary to or as an alternative to the inclination or the curved shape of the bottom face, the outlet can be designed so that its height above the bottom face of the tank varies with the quantity of water available in the tank. A solution to this is to let the outlet comprise a flexible tube or the like and a float which makes the outlet follow the surface of water. The float can be the outlet tube itself, but it can also be a separate float. By adjusting the floatability, it is possible to determine whether the outlet should discharge water from the absolutely uppermost layer or whether it should discharge water from a layer which is somewhat lower. The selection of which layer is to be discharged is to a large extent determined by the types of impurities in the water and by the floatability and settling capability of these impurities. In many cases, it is not desirable to remove the absolutely uppermost layer since this often contains certain impurities that do not settle. Correspondingly, it is also in most cases not desirable to remove the lowermost layer since this contains the polluting particles that quickly fall to the bottom of a stagnant quantity of water.

Moreover it is, of course, possible to connect sensors and control units and connect these to a computer, thereby allowing remote control or remote reading of the function and status of the separation apparatus. For instance, environmental inspectors or service personnel can supervise the function of the separation apparatus, if desired.

A result of the above-described embodiment and its variants is that it is possible to arrange the separation apparatus even in positions that are most difficult to reach. The various units of the separation apparatus do not require very large ground areas. Moreover, they are intended to be buried, thus allowing them to become fused into the surroundings and not interfering with the view. In the archipelago where the layer of soil is often very thin, implying that there will not be sufficient space in the vertical direction to bury the various components of the separation apparatus, it may be feasible to arrange the separation apparatus on a pontoon and lower the various parts to a suitable level in the water.

In some cases, an additional sludge separator or filtering unit, such as a sand filter or the like, can be arranged between the pump and the water tank.

The main purpose of the conveyor is to convey solid particles up to the tank and to hold the filtering unit above the water outlet free from solid particles; thus the screw conveyor can be replaced by some other type of conveyor, for instance it is possible to use a piston pump.

1. An apparatus for separating impurities from waste water, comprising
a separating portion (40; 140) for separating solid impurities from the waste water,
a collecting vessel (20; 120) for collecting the separated solid impurities, and
a conveyor (30; 130) extending from the separating portion (40; 140) to the collecting vessel (20; 120),
the separating portion (40; 140) comprising
an inlet (41a; 141a) through which waste water is passed to the separation apparatus,
a water outlet (44; 144) for removing water, and
an impurity outlet (43; 143) for removing the solid impurities, which is connected to the collecting vessel (20), characterised by
a water storage tank (10; 110) for storing at least partly purified waste water,
the water outlet (44; 144) being connected to the water storage tank (10), and
the water storage tank (10; 110) and the collecting vessel (20; 120) being arranged to be in heat transfer contact with each other.

2. An apparatus as claimed in claim 1, wherein the water outlet (44; 144) of the separating portion (40;
140) is located below the impurity outlet (43; 143) of the separating portion (40; 140).

3. An apparatus as claimed in claim 1 or 2, wherein the water outlet (44; 144) of the separating portion (40; 140) is located below the inlet (41a; 141a) of the separating portion (40; 140).

4. An apparatus as claimed in any one of the preceding claims, wherein the separating portion (40; 140) is located below the collecting vessel (20; 120).

5. An apparatus as claimed in any one of the preceding claims, wherein the water storage tank (10; 110) and the collecting vessel (20; 120) are jointly thermally insulated from the surroundings.

6. An apparatus as claimed in any one of the preceding claims, wherein the conveyor (30; 130) is adapted to extend through the impurity outlet (43; 143) into the separating portion (40; 140), to be in contact with waste water supplied to the separating portion (40; 140), and to separate solid impurities from the waste water and entrain them to the collecting vessel (20; 120).

7. An apparatus as claimed in any one of the preceding claims, wherein the conveyor (30; 130) is adapted to extend along the water outlet (44; 144) of the separating portion (40; 140) and out of the separating portion (40; 140) through the impurity outlet (43; 143) of the separating portion (40; 140).

8. An apparatus as claimed in any one of the preceding claims, wherein the conveyor (30; 130) comprises a screw conveyor (31; 131).

9. An apparatus as claimed in claim 8, wherein the screw conveyor (31; 131) is arranged inside a pipe (32; 132) which extends between the separating portion (40; 140) and the collecting vessel (20; 120).

10. An apparatus as claimed in any one of the preceding claims, wherein the water storage tank (110) is divided into a first and a second tank (112, 113).

11. An apparatus as claimed in claim 10, wherein the first and the second tank (112, 113) communicate with each other through an overflow from the second tank (113) to the first tank (112).

12. An apparatus as claimed in claim 10 or 11, wherein the first tank (112) is arranged above the second tank (113).

13. An apparatus as claimed in any one of claims 10-12, wherein the first tank (112) is arranged in the upper part of the second tank (113).

14. An apparatus as claimed in any one of the preceding claims, which further comprises a first, upwardly open and downwardly tapering hopper (114a) which is adapted to receive water from the separating portion (40; 140) and pass this to the water storage tank (10; 110).

15. An apparatus as claimed in claim 14, wherein said hopper (114a) is arranged in the water storage tank (10; 110).

16. An apparatus as claimed in claim 14 or 15, wherein said hopper (114a) is adapted to pass water to the second tank (113).

17. An apparatus as claimed in claim 16, which further comprises a second, downwardly open and upwardly tapering hopper (114b) which communicates with said first hopper (114a).

18. An apparatus as claimed in claim 17, wherein the first hopper (114a) is arranged in the first tank (112) and the second hopper (114b) is arranged in the second tank (113).

19. A method for separating organic waste from waste water, comprising the steps of
supplying waste water to a separating portion (40; 140),
separating in the separating portion (40; 140) solid impurities from the waste water,
passing the impurities from the separating portion (40; 140) to a collecting vessel (20; 120),
characterised in
passing the partly purified waste water from the separating portion (40; 140) to a water storage tank (10; 110), and
that the partly purified waste water in the water storage tank (10; 110) transfers heat to the impurities in the collecting vessel (20; 120).

20. A method as claimed in claim 19, wherein the partly purified waste water is passed from the separating portion (40; 140) at least partly by gravity through a waste water outlet (44; 144) which is located below the impurity outlet (43; 143) of the separating portion (40; 140).

21. A method as claimed in claim 19 or 20, wherein the partly purified waste water is passed from the separating portion (40; 140) at least partly by gravity through a waste water outlet (44; 144) which is located below the inlet (41a; 141a) of the separating portion (40; 140).

22. A method as claimed in any one of claims 19-21, wherein the impurities are conducted upwards from the separating portion (40; 140) to the collecting vessel (20; 120).

23. A method as claimed in any one of claims 19-22, wherein the conveyor (30; 130) through the impurity outlet (43; 143) extends into the separating portion (40; 140) so as to be in contact with waste water that is supplied to the separating portion (40; 140) and separate from the waste water solid impurities and entrain them to the collecting vessel (20; 120).

24. A method as claimed in any one of claims 19-23, wherein the conveyor (30; 130) extends along the water outlet (44; 144) of the separating portion (40; 140) and out of the separating portion (40; 140) through the impurity outlet (43; 143) of the separating portion (40; 140).

25. A method as claimed in any one of claims 19-24, wherein the water from the separating portion (140) is passed to a second tank (113) and from there to a first tank (112).

26. A method as claimed in any one of claims 19-25, wherein the water from the separating portion (140) is passed to a first, upwardly open and downwardly tapering hopper (114a) and from this to the water storage tank (10; 110).

27. A method as claimed in claim 26, wherein the water is passed from the first hopper (114a) to a second, downwardly open and upwardly tapering hopper (114b) which is in fluid communication with the first hopper (114a).

28. A method as claimed in any one of claims 25-27, wherein the water is passed from the second tank (113) to the first tank (112) through a number of overflows (115).
